(19) United States
(12) Patent Application Publication
(10) Pub. No.: US 2014/0176473 A1
(43) Pub. Date: Jun. 26, 2014

(54) TOUCH PANEL AND DRIVING METHOD THEREOF

(71) Applicant: WINTEK CORPORATION, Taichung City (TW)

(72) Inventors: Ming-Chuan Lin, Taichung City (TW); Wen-Hung Wang, Taichung City (TW); Pei-Fang Tsai, Taichung City (TW); Shyh-Jeng Chen, Taichung City (TW)

(73) Assignee: WINTEK CORPORATION, Taichung City (TW)

(21) Appl. No.: 14/140,476

(22) Filed: Dec. 25, 2013

(30) Foreign Application Priority Data
Dec. 25, 2012 (TW) 101149753

(51) Int. Cl. G06F 3/041

(52) U.S. Cl. CPC G06F 3/0418
USPC 345/173

(57) ABSTRACT

A touch panel includes a substrate, a plurality of electrodes arranged on the substrate for transmitting a plurality of driving signals and generating a plurality of sensing signals according to the plurality of driving signals, and a driving element. The driving element is for driving the plurality of electrodes, wherein the driving element is disabled within a predetermined period following transition of a common voltage of a display panel.

### BACKGROUND OF THE INVENTION

1. Field of the Invention

The present invention relates to a touch panel and a driving method thereof, and more particularly, to a touch panel capable of avoiding influence from common voltage noises and a driving method thereof.

2. Description of the Prior Art

Please refer to FIG. 1. FIG. 1 is a diagram showing waveforms of a common voltage and a noise signal thereof. As shown in FIG. 1, in order to drive pixels of a display panel, the common voltage Vcom of the display panel may transit at each display cycle. However, when the common voltage Vcom starts to transit (such as rising from a low voltage level to a high voltage level, or dropping from the high voltage level to the low voltage level), the common voltage Vcom may generate the noise signal N, and the noise signal N generated by the common voltage Vcom may electromagnetically interfere with other signals, such as interfering with sensing signals of a touch panel.

In order to prevent the noise signal N generated in transition of the common voltage Vcom from interfering with the sensing signals of the touch panel, the touch panel of the prior art is attached with an electromagnetic shielding film for blocking electromagnetic waves of the noise signal N of the common voltage Vcom. However, attaching the electromagnetic shielding film will increase complexity of structure and manufacturing process of the touch panel.

### SUMMARY OF THE INVENTION

The present invention provides a touch panel comprising a substrate; a plurality of electrodes arranged on the substrate for transmitting a plurality of driving signals and generating a plurality of sensing signals according to the plurality of driving signals; and a driving element. The driving element is for driving the plurality of electrodes, wherein the driving element is disabled within a predetermined period following transition of a common voltage of a display panel.

The present invention further provides a touch display device comprising a display panel and a touch panel. The display panel comprises a pixel array for displaying images according a plurality of scanning signals, a plurality of data signals, and a common voltage; and a driving circuit for providing the plurality of scanning signals, the plurality of data signals, and the common voltage to the pixel array. The touch panel comprises a substrate; a plurality of electrodes arranged on the substrate for transmitting a plurality of driving signals and generating a plurality of sensing signals according to the plurality of driving signals; and a driving element. The driving element is for driving the plurality of electrodes, wherein the driving element is disabled within a predetermined period following transition of the common voltage.

The present invention further provides a driving method of touch panel. The method comprises providing a touch panel. The touch panel comprises a plurality of electrodes for transmitting a plurality of driving signals and generating a plurality of sensing signals according to the plurality of driving signals; detecting transition of a common voltage of a display panel; controlling the touch panel to stop generating touch data according to the plurality of sensing signals within a predetermined period following transition of the common voltage; and controlling the touch panel to generate touch data according to the plurality of sensing signals after the predetermined period following the transition of the common voltage.

In contrast to the prior art, the touch panel of the present invention can disable the driving element (such as disabling the transmitting unit, the receiving unit, and/or the processing unit) according to transition time of the common voltage for preventing generating wrong touch data. The touch panel of the present invention requires no electromagnetic shielding film for blocking electromagnetic waves of the noise signal of the common voltage. Therefore, the present invention can simplify the structure and manufacturing process of the touch panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing waveforms of a common voltage and a noise signal thereof.

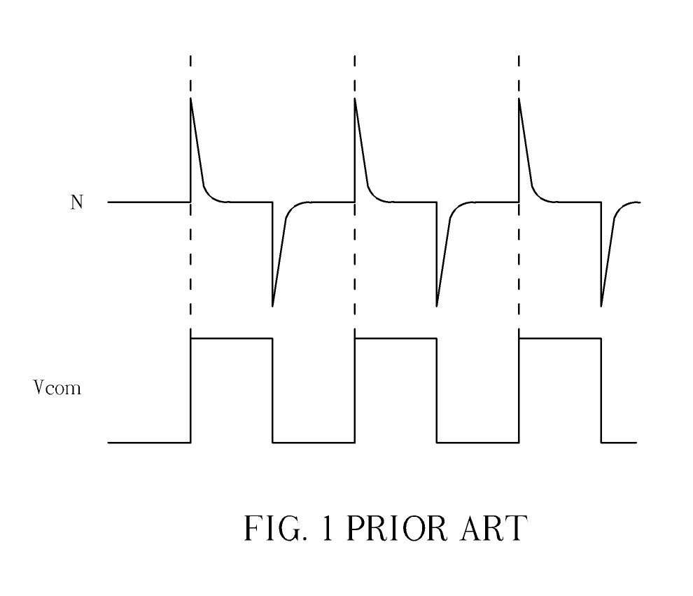

FIG. 2 is a diagram showing a touch display device of the present invention.

FIG. 3 is a diagram showing arrangement of a touch panel in FIG. 2.

FIG. 4 is a diagram illustrating the touch panel of the present invention enabling and disabling a sensing function.

FIG. 5 is a diagram showing another embodiment of the touch panel of the present invention.

FIG. 6 is a diagram showing another embodiment of the touch display device of the present invention.

FIG. 7 is a flowchart showing a driving method of the touch panel of the present invention.

### DETAILED DESCRIPTION

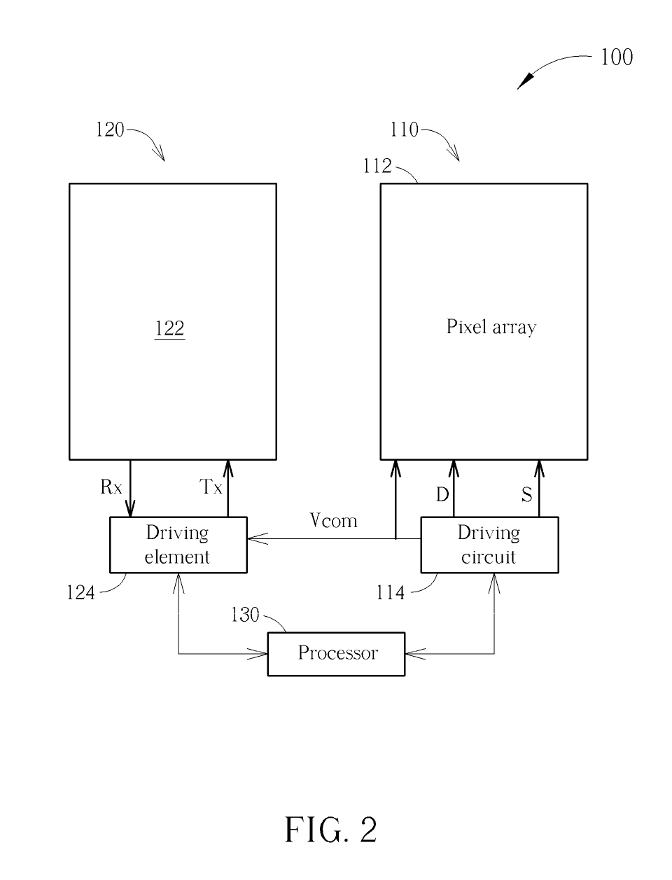

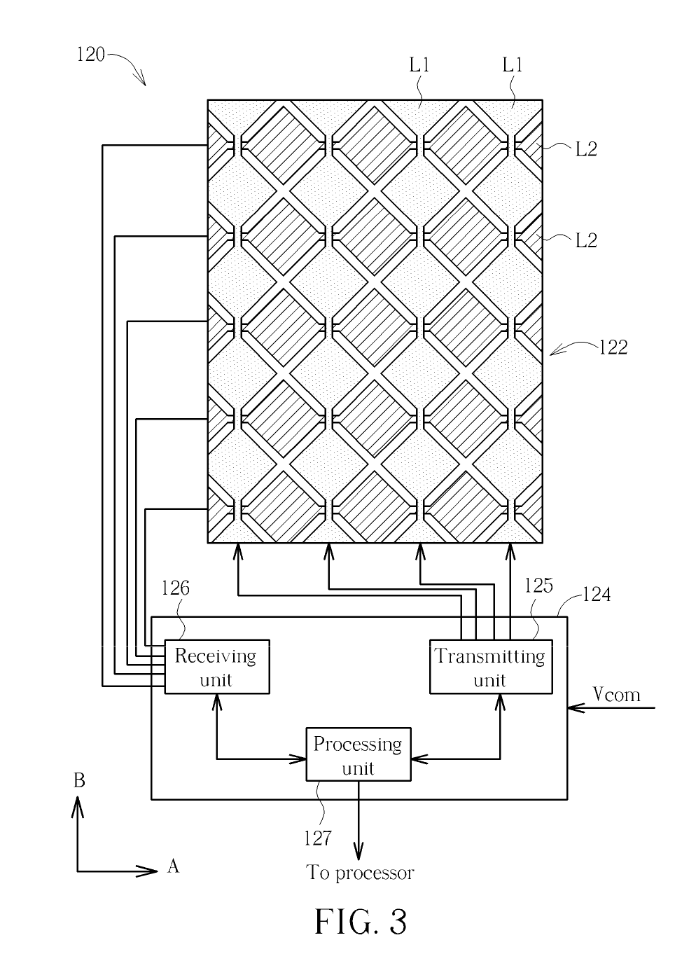

Please refer to FIG. 2 and FIG. 3. FIG. 2 is a diagram showing a touch display device of the present invention. FIG. 3 is a diagram showing arrangement of the touch panel in FIG. 2. As shown in figures, the touch display device 100 of the present invention comprises a display panel 110, a touch panel 120, and a processor 130. The display panel 110 comprises a pixel array 112, and a driving circuit 114. The driving circuit 114 is for providing a plurality of scanning signals S, a plurality of data signals D, and a common voltage Vcom to the pixel array 112. The pixel array 112 is for displaying images according to the plurality of scanning signals S, the plurality of data signals D, and the common voltage Vcom. The touch panel 120 comprises a substrate 122, a plurality of first sensing electrodes L1, a plurality of second sensing electrodes L2, and a driving element 124. The plurality of first sensing electrodes L1 is arranged on the substrate 122 along a first direction A for transmitting a plurality of driving signals Tx. The plurality of second sensing electrodes L2 is arranged on the substrate 122 along a second direction B different from the first direction A for generating a plurality of sensing signals Rx according to the plurality of driving signals Tx. The driving element 124 comprises a transmitting unit 125, a receiving unit 126, and a processing unit 127. The transmitting unit 125 is electrically connected to the plurality of first sensing electrodes L1 for outputting the plurality of driving signals Tx. The receiving unit 126 is electrically connected to the plurality of second sensing electrodes L2 for receiving the plurality of sensing signals Rx generated by the plurality of second sensing electrodes L2. The processing unit 127 is for generating touch data according to the plurality of sensing signals Rx. The processor 130 controls operation of the touch display device 100 according to the touch data generated by the driving element 124, such as moving a cursor displayed on the display panel 110. In the embodiments of the present invention, the first sensing electrodes L1 are not limited to transmit the driving signals Tx, and the second sensing electrodes L2 are not limited to generate the plurality of sensing signals Rx according to the plurality of driving signals Tx. Functions of the first sensing electrodes L1 and the second sensing electrodes L2 can be reversed.

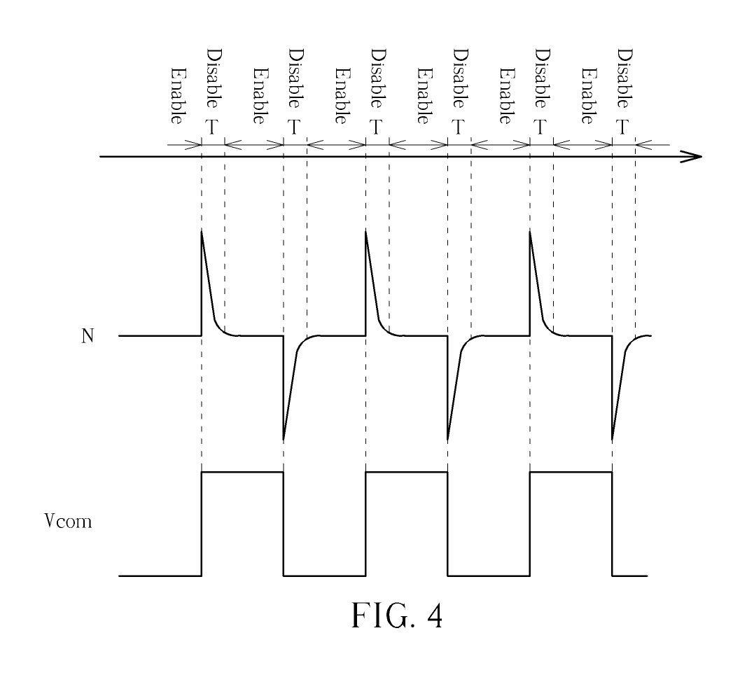

Please refer to FIG. 4, and refer to FIG. 2 and FIG. 3 as well. FIG. 4 is a diagram illustrating the touch panel of the present invention enabling and disabling a sensing function. As shown in FIG. 4, in order to prevent the noise signal N generated in transition of the common voltage Vcom of the display panel from interfering with the sensing signals Rx of the touch panel, the driving element 124 of the touch panel 120 is electrically connected to the driving circuit 114 of the display panel 110 for receiving the common voltage Vcom. Thus, the driving element 124 can determine and acquire transition time of the common voltage Vcom, and then disable the transmitting unit 125, the receiving unit 126, and/or the processing unit 127 within a predetermined period following the transition of the common voltage Vcom.

For example, when the common voltage Vcom starts to transit, the driving element 124 can disable the transmitting unit 125 within a predetermined period T for stopping the transmitting unit 125 outputting the plurality of driving signals Tx to the first sensing electrodes L1, so as to further stop generating touch data to the processor 130; when the common voltage Vcom starts to transit, the driving element 124 also can disable the receiving unit 126 within the predetermined period T for stopping the receiving unit 126 receiving the plurality of sensing signals Rx generated by the second sensing electrodes L2, so as to further stop generating touch data to the processor 130; or when the common voltage Vcom starts to transit, the driving element 124 can disable the processing unit 127 within the predetermined period T for stopping the processing unit 127 generating touch data according to the plurality of sensing signals Rx. Thus, the driving element 124 is prevented from providing inaccurate touch data to the processor 130, in order to avoid the processor 130 performing wrong operation. In addition, after the predetermined period T following the transition of the common voltage Vcom, the driving element 124 can enable the transmitting unit 125, the receiving unit 126, and/or the processing unit 127 again, and generate touch data to the processor 130 according to the plurality of sensing signals Rx.

The above predetermined period T can be determined according to a signal to noise ratio (SNR) of the sensing signals Rx. For example, if the signal to noise ratio of the sensing signal RX lower than a predetermined value may cause errors on the touch data, the driving element 124 can measure a period when the signal to noise ratio of the sensing signals Rx is lower than the predetermined value under the interference of the noise signal of the common voltage Vcom, and further determine the above predetermined period T. Therefore, the driving element 124 can ensure generating accurate touch data.

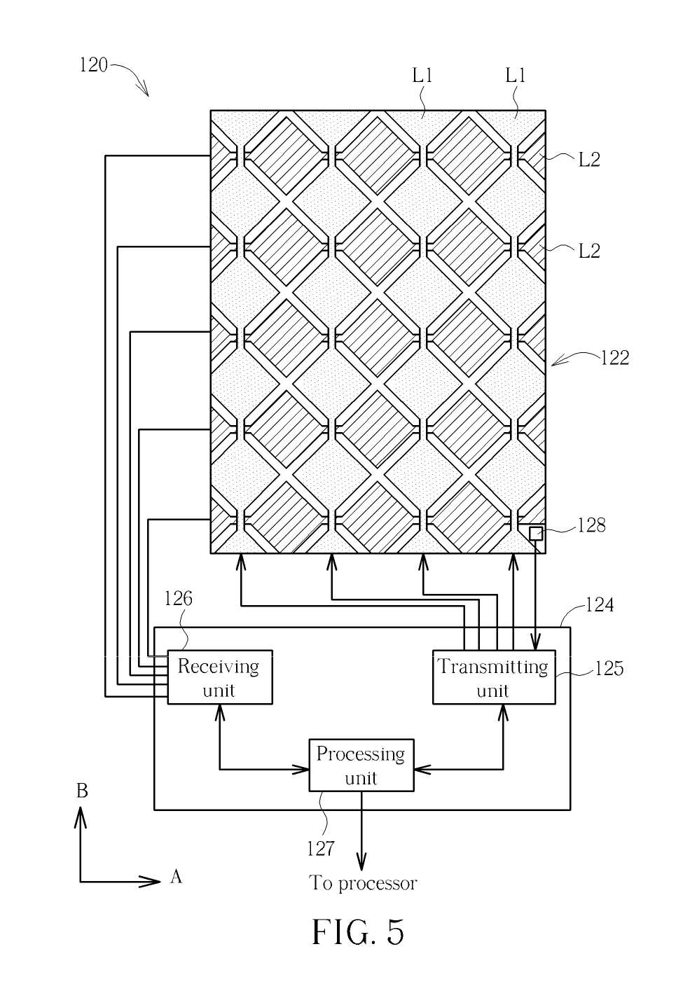

Please refer to FIG. 5. FIG. 5 is a diagram showing another embodiment of the touch panel of the present invention. As shown in FIG. 5, the touch panel 120 can further comprise at least one sensing unit 128 arranged on the substrate 122. The sensing unit 128 is electrically connected to the driving element 124, and the sensing unit 128 can sense the transition of the common voltage Vcom by way of electromagnetic induction. Therefore, the driving element 124 can determine and acquire the transition time of the common voltage Vcom without being electrically connected to the driving circuit 114 of the display panel 110. The sensing unit 128 can be any kind of sensing element.

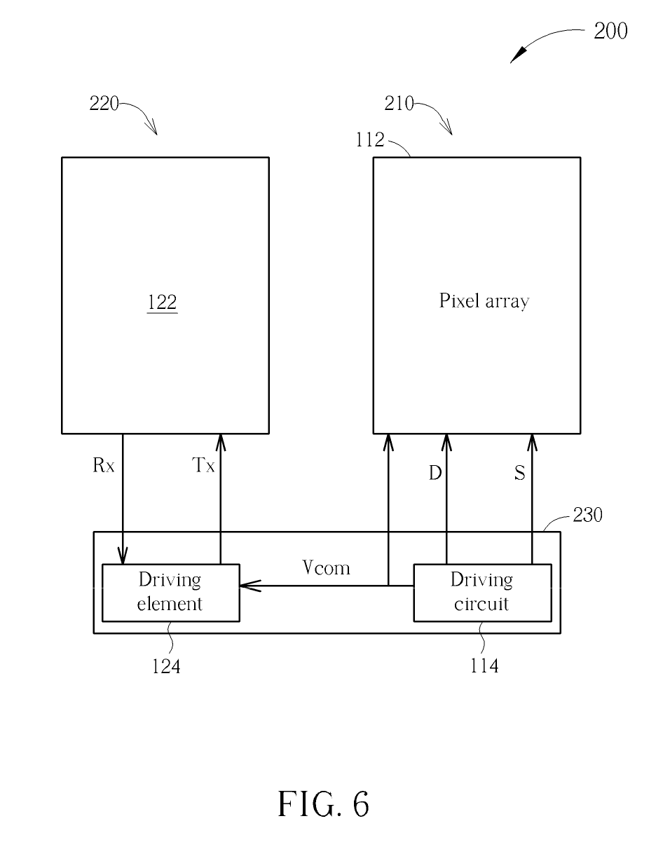

Please refer to FIG. 6. FIG. 6 is a diagram showing another embodiment of the touch display device 200 of the present invention. As shown in FIG. 6, the driving element 224 of the touch panel 220 can be integrated with the driving circuit 214 of the display panel 210 in the processor 230. Therefore, size and cost of the touch display device 200 of the present invention can be further reduced.

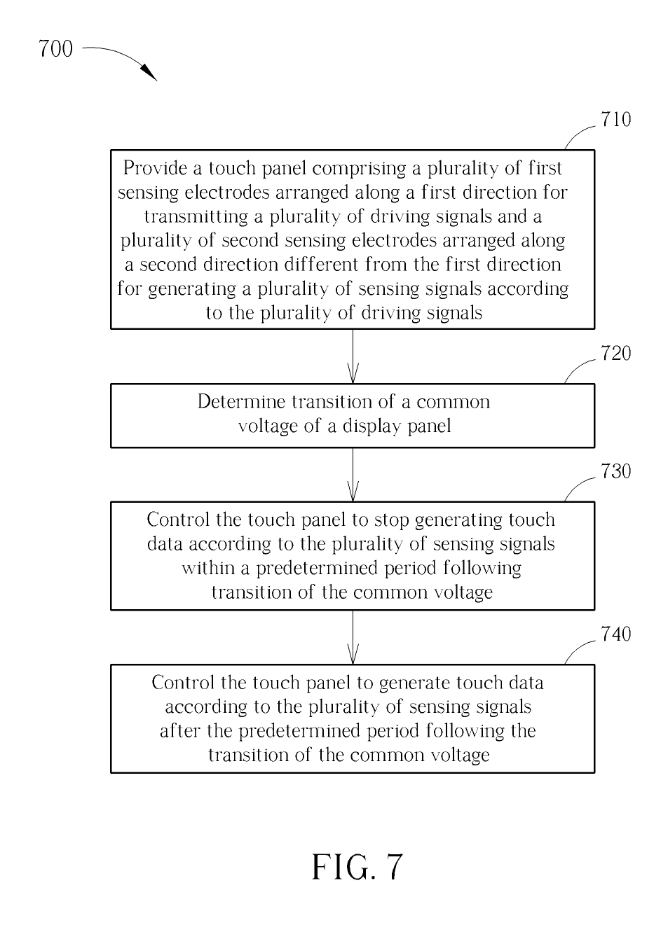

Please refer to FIG. 7. FIG. 7 is a flowchart 700 showing a driving method of the touch panel of the present invention. The flowchart 700 of the driving method of the touch panel of the present invention comprises the following steps:

Step 710: Provide a touch panel comprising a plurality of first sensing electrodes arranged along a first direction for transmitting a plurality of driving signals and a plurality of second sensing electrodes arranged along a second direction different from the first direction for generating a plurality of sensing signals according to the plurality of driving signals;

Step 720: Determine transition of a common voltage of a display panel;

Step 730: Control the touch panel to stop generating touch data according to the plurality of sensing signals within a predetermined period following transition of the common voltage; and

Step 740: Control the touch panel to generate touch data according to the plurality of sensing signals after the predetermined period following the transition of the common voltage.

In contrast to the prior art, the touch panel of the present invention can disable the driving element (such as disabling the transmitting unit, the receiving unit, and/or the processing unit) according to the transition time of the common voltage for preventing generating wrong touch data. The touch panel of the present invention requires no electromagnetic shielding film for blocking electromagnetic waves of the noise signal of the common voltage. Therefore, the present invention can simplify complexity of the structure and manufacturing process of the touch panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel, comprising:
a substrate;
a plurality of electrodes arranged on the substrate for transmitting a plurality of driving signals, and generating a plurality of sensing signals according to the plurality of driving signals; and
a driving element for driving the plurality of electrodes;
wherein the driving element is disabled within a predetermined period following transition of a common voltage of a display panel.

2. The touch panel of claim 1, wherein the driving element comprises:
a transmitting unit electrically connected to the plurality of electrodes for outputting the plurality of driving signals;
a receiving unit electrically connected to the plurality of electrodes for receiving the plurality of sensing signals; and
a processing unit for generating touch data according to the plurality of sensing signals;
wherein the transmitting unit, the receiving unit, and/or the processing unit of the driving element are disabled within the predetermined period following the transition of the common voltage.

3. The touch panel of the claim 1, wherein the plurality of electrodes comprises:
a plurality of first sensing electrodes arranged on the substrate along a first direction for transmitting the plurality of driving signals; and
a plurality of second sensing electrodes arranged on the substrate along a second direction different from the first direction for generating the plurality of sensing signals according to the plurality of driving signals.

4. The touch panel of claim 1, wherein the predetermined period is determined according to a signal to noise ratio (SNR) of the plurality of sensing signals.

5. The touch panel of claim 1, further comprising at least one sensing unit arranged on the substrate, the at least one sensing unit being electrically connected to the driving element for sensing the transition of the common voltage.

6. The touch panel of claim 1, wherein the driving element is electrically connected to a driving circuit of the display panel for receiving the common voltage.

7. The touch panel of claim 6, wherein the driving element is integrated with the driving circuit of the display panel.

8. A touch display device, comprising:
a display panel, comprising:
a pixel array for displaying images according a plurality of scanning signals, a plurality of data signals, and a common voltage; and
a driving circuit for providing the plurality of scanning signals, the plurality of data signals, and the common voltage to the pixel array; and
a touch panel, comprising:
a substrate;
a plurality of electrodes arranged on the substrate for transmitting a plurality of driving signals, and generating a plurality of sensing signals according to the plurality of driving signals; and
a driving element for driving the plurality of electrodes;
wherein the driving element is disabled within a predetermined period following transition of the common voltage.

9. The touch display device of claim 8, wherein the driving element comprises:
a transmitting unit electrically connected to the plurality of electrodes for outputting the plurality of driving signals;
a receiving unit electrically connected to the plurality of electrodes for receiving the plurality of sensing signals; and
a processing unit for generating touch data according to the plurality of sensing signals;
wherein the transmitting unit, the receiving unit, and/or the processing unit of the driving element are disabled within a predetermined period following the transition of the common voltage.

10. The touch display device of claim 8, wherein the plurality of electrodes comprises:
a plurality of first sensing electrodes arranged on the substrate along a first direction for transmitting the plurality of driving signals; and
a plurality of second sensing electrodes arranged on the substrate along a second direction different from the first direction for generating the plurality of sensing signals according to the plurality of driving signals.

11. The touch display device of claim 8, wherein the predetermined period is determined according to a signal to noise ratio (SNR) of the plurality of sensing signals.

12. The touch display device of claim 8, wherein the touch panel further comprises at least one sensing unit arranged on the substrate, the at least one sensing unit being electrically connected to the driving element for sensing the transition of the common voltage.

13. The touch display device of claim 8, wherein the driving element is electrically connected to the driving circuit of the display panel for receiving the common voltage.

14. The touch display device of claim 8, wherein the driving element is integrated with the driving circuit of the display panel in a processor.

15. A driving method of a touch panel, comprising:
providing a touch panel, the touch panel comprising a plurality of electrodes for transmitting a plurality of driving signals and generating a plurality of sensing signals according to the plurality of driving signals;
determining transition of a common voltage of a display panel;
controlling the touch panel to stop generating touch data according to the plurality of sensing signals within a predetermined period following transition of the common voltage; and
controlling the touch panel to generate touch data according to the plurality of sensing signals after the predetermined period following the transition of the common voltage.

16. The driving method of claim 15 further comprising determining the predetermined period according to a signal to noise ratio (SNR) of the plurality of sensing signals.
